(19) United States
(12) Patent Application Publication
(10) Pub. No.: US 2016/0344791 A1
(43) Pub. Date: Nov. 24, 2016

(54) NETWORK NODE BANDWIDTH MANAGEMENT

(71) Applicant: MICROSOFT TECHNOLOGY LIMITED, LLC, Redmond, WA (US)

(72) Inventors: Darrin Veit, Sammamish, WA (US); Krassimir Karamfilov, Sammamish, WA (US)

(73) Assignee: MICROSOFT TECHNOLOGY LIMITED, LLC, Redmond, WA (US)

(21) Appl. No.: 14/717,951

(22) Filed: May 20, 2015

(51) Int. Cl. H04L 29/06

(52) U.S. Cl. CPC H04L 65/80; H04L 65/60; H04L 65/601

(57) ABSTRACT

A system includes a memory device configured to store instructions and a processing device configured to execute the instructions stored in the memory to receive a network identifier uniquely identifying a network segment that is operating at or near capacity, identify at least one streaming server that is streaming to the network segment based at least in part on the network identifier, and apply a rate limiting value to the at least one streaming server to limit a stream rate to at least one client in the network segment.

### TECHNICAL FIELD

The present disclosure relates to network node bandwidth management.

### BACKGROUND

Network congestion occurs when data traffic exceeds a capacity of a network segment, link, or node, which may adversely affect the network's quality of service and may result in latency and data loss to an end user. Latency or delay on packets transmitted from source to destination may seriously slow or disrupt operations of computer systems. Latency may also destroy the efficacy of streaming video, audio, and multimedia product and service delivery by causing visible or audible gaps in the presentation of the content encoded in the data to the end user. Latency may cause computer systems to freeze or otherwise stop.

Such situations may be distracting and undesirable in video conferences, video-on-demand, telephone calls, and the like. Latency may further be problematic when large files are being downloaded because it slows the process considerably. Slower response times, in turn, may adversely impact the responsiveness of more interactive applications or may otherwise negatively affect the end user's experience. And while data packet loss resulting from network congestion may be countered by retransmission, there is a continuing need to improve and effectively manage bandwidth to avoid network congestion.

### BRIEF DRAWINGS DESCRIPTION

The present disclosure describes various embodiments that may be understood and fully appreciated in conjunction with the following drawings:

FIGS. 1A, 1B, and 1C diagram embodiments of a system according to the present disclosure;

FIG. 2 diagrams an embodiment of a method of managing network node bandwidth according to the present disclosure;

FIG. 3 diagrams an embodiment of a method of managing network node bandwidth according to the present disclosure; and

FIG. 4 diagrams an embodiment of a computing system that executes the system according to the present disclosure.

### DETAILED DESCRIPTION

The present disclosure describes embodiments with reference to the drawing figures listed above. Persons of ordinary skill in the art will appreciate that the description and figures illustrate rather than limit the disclosure and that, in general, the figures are not drawn to scale for clarity of presentation. Such skilled persons will also realize that many more embodiments are possible by applying the inventive principles contained herein and that such embodiments fall within the scope of the disclosure which is not to be limited except by the claims.

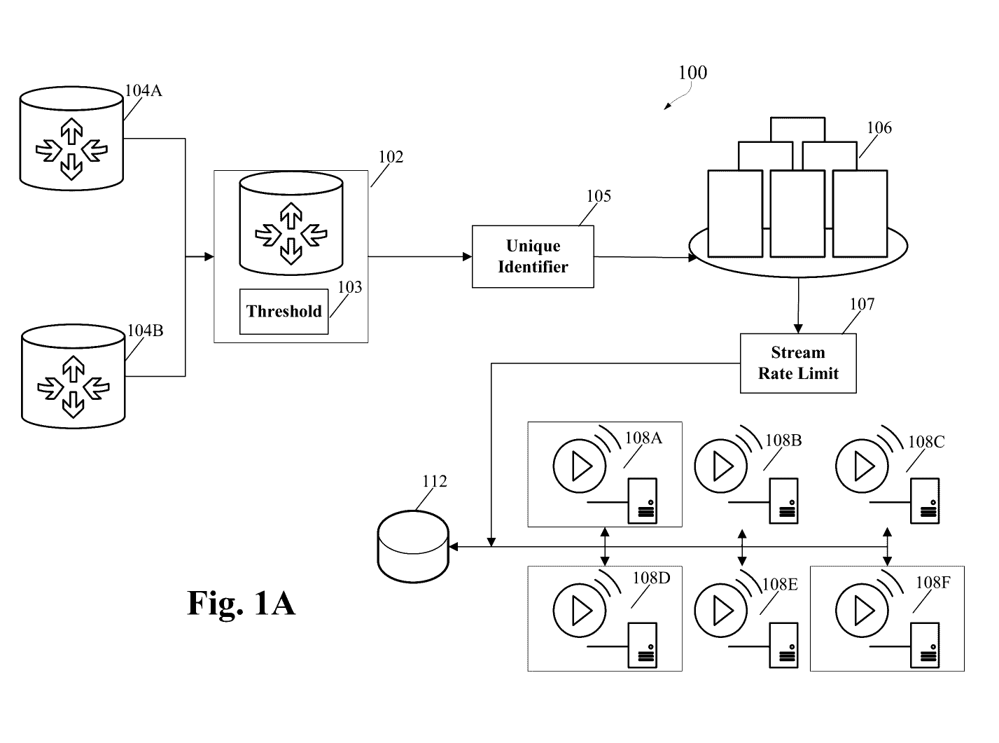

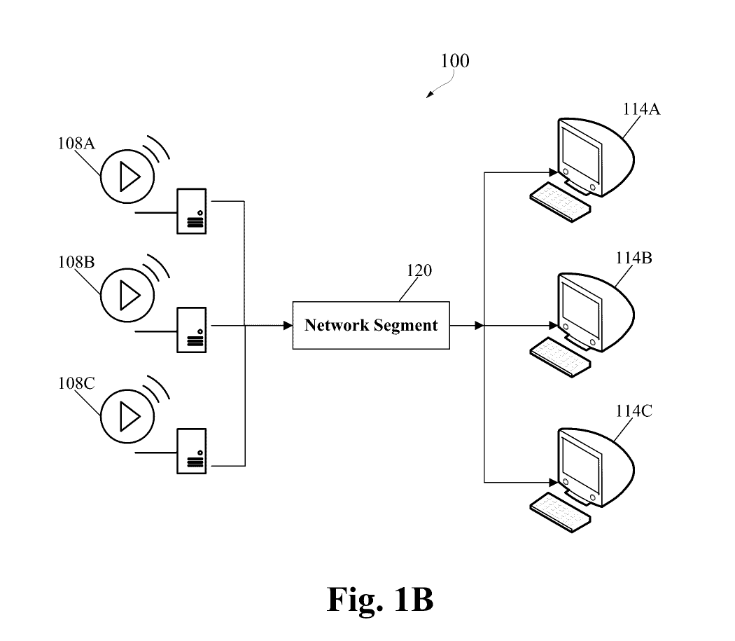

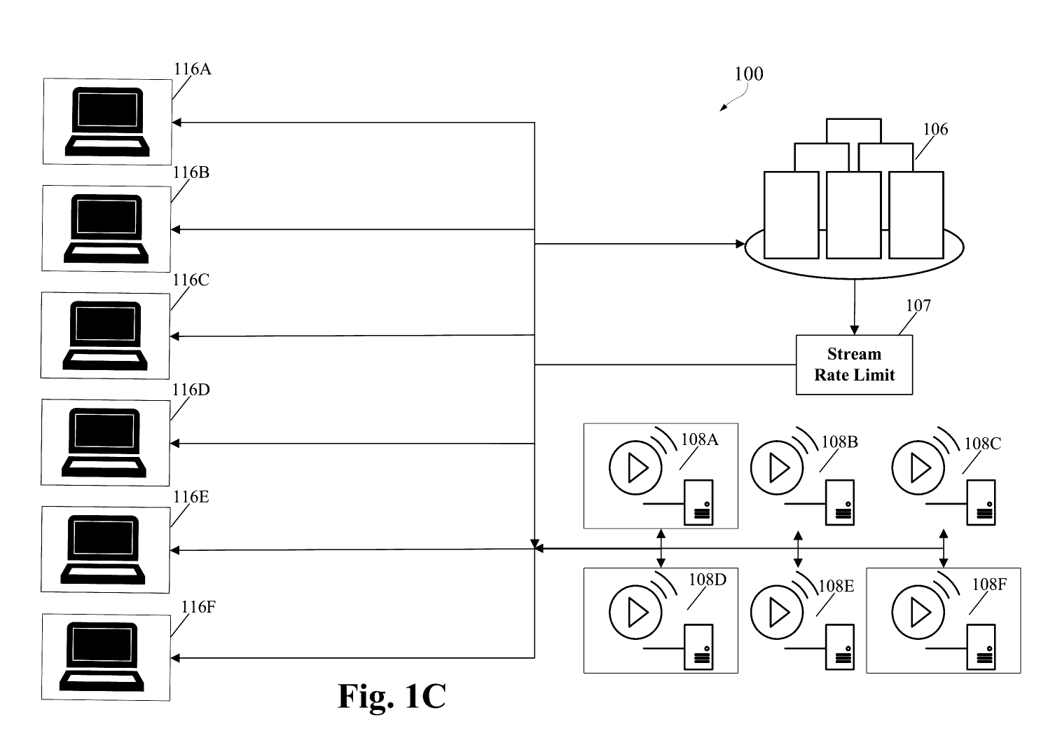

FIGS. 1A, 1B, and 1C diagram embodiments of a system 100 according to the present disclosure. Referring to FIGS. 1A, 1B, and 1C, system 100 comprises a plurality of network devices 104A and 104B interconnected to a network node 102. Network devices 104A and 104B may be any kind of computing device capable of interconnection with other computing devices to exchange data through a network (not shown), e.g., routers, gateways, servers, clients, personal computers, mobile devices, laptop computers, tablet computers, and the like. Network node 102 may be a connection or redistribution point in a network that is capable of creating, receiving information from or transmitting information to network devices 104A and 104B. Network node 102 may be any kind of computing device capable of interconnection with network devices 104A and 104B, e.g., cable modem termination system, router, gateway, server, bridge, switch, hub, repeater, and the like, to exchange data through a network (not shown).

Network devices 104A and 104B may connect to network node 102 to form a network segment or link 120. A network segment or link may be a logical or physical group of computing devices, e.g., network devices 104A and 104B, which share a network resource, e.g., network node 102. Network segment 120 may be, more generally, an electrical connection between networked devices, the nature and extent of which depends on the specific topology and equipment used in system 100. In an embodiment, network node 102 may be a device that handles data at the data link layer (layer two), at the network layer (layer three), or the like. In an embodiment, network node 102 may be an Internet Service Provider (ISP) configured to provide access to the internet, usually for a fee. In this circumstance, network node 102 may be a gateway to all other servers or computing devices on a global communications network. A person of ordinary skill in the art should recognize that system 100 may have any known network topology or include any known computing devices or network equipment.

In an embodiment, it may be desirable to transmit network communications across system 100 based, at least in part, on an internet protocol (IP). An IP address may assign a numerical label to, e.g., network node 102, participating in a system 100 utilizing internet protocol for communication. An IP address may provide host addressing, network interface identification, location addressing, destination addressing, source addressing, or the like.

In an embodiment, network 100 may transmit communications to other computing devices using packets. A packet may relate to a formatted unit of data carried by or over a packet switched system 100. In some circumstances, a packet may comprise control information, such as header data, footer data, trailer data, or the like, and user data, such as a payload, transmitted data, audio or video content, and/or the like. In at least one example embodiment, a packet header comprises data to aid in delivery of user data such as a destination media access control address, a source media access control address, a virtual address, or the like.

In an embodiment, network node 102 may network devices 104A and 104B to form network segment 120. Network node 102 may further link network devices 104A and 104B to streaming control device 106. Network node 102 may include a cable modem termination system, router, gateway, server, bridge, switch, hub, repeater, and the like that processes and switches, routes, or transmits data to and from network devices 104A or 104B or to and from streaming control device 106 in network 100. A person of ordinary skill in the art should recognize that network segment 120 may comprise other network devices or equipment and is shown only with network devices 104A and 104B and network node 120 for simplicity.

In an embodiment, network 100 may support interconnectivity between various networks similar to network 100. For example, network node 102 may communicate a packet towards a destination node (not shown) via one or more additional intermediate devices connected directly or indirectly with network 100.

Network devices 104A or 104B may related to at least one network node, router, switch, server, virtual machine, virtual server, or the like. In an embodiment, network device 104A may be configured to receive data from network device 104B. Similarly, network device 104A or 104B may be configured to transmit data to other network devices within network 100 or outside network 100 using other nodes or network devices.

In an embodiment, network node 102 may be connected to a streaming control device 106, in turn, connected to a plurality of streaming servers 108A-F. Streaming control device 106 may be one or more computing devices configured to control the plurality of streaming servers 108A-F to deliver or stream data, e.g., audio files, video files, data files, web pages, gaming files, teleconferencing files, or the like, to specific user computing devices, e.g., streaming client computing devices 114A, 114B, or 114C through network segment or link 120. Streaming servers 108A-F may be physical servers or virtual machines operating on a physical server. In an embodiment, each of streaming servers 108A-F may be a virtual machine operating on at least a portion of a physical server. A virtual machine as is well known to a person or ordinary skill in the art may be an emulation of a particular computer system, e.g., any of streaming servers 108A-F. Virtual machines may be implemented using hardware, software of a combination of both.

Streaming control device 106 may include any kind of computing device known to a person of ordinary skill in the art. Likewise, streaming servers 108A-F and computing devices 114A, 114B, or 114C may include any kind of computing device known to a person of ordinary skill in the art.

In an embodiment, network segment 120 may represent a portion of network 100 including network devices 104A or 104B or network node 102 or any combination thereof. The nature and extent of segment 120 may depend on network topology, devices, and the like. Network segment 120 may represent a connection between streaming servers 108A, 108D, or 108F and user computing devices 114A, 114B, or 114C or between network devices 104A or 104B and network node 102.

Each of streaming servers 108A-F may include a data source (not shown separately from streaming servers 108A-F) or may have access to a common data source 112 to store data, e.g., audio files, video files, data files, web pages, or other content. Data sources like common data source 112 may be any kind of storage or memory device implementing any kind of storage or memory technology in any size known to a person of ordinary skill in the art as appropriate for implementation in network 100.

Streaming servers 108A-F may transmit or receive data from computing devices 114A, 114B, or 114C, e.g., video and audio files, over network 100. In an embodiment, streaming servers 108A-F may transmit or receive data from computing devices 114A, 114B, or 114C as a steady, continuous flow, allowing playback to proceed while subsequent data is being received. Put differently, computing devices 114A, 114B, or 114C may present data to an end-user while data is being delivered from streaming servers 108A-F. Computing devices 114A, 114B, or 114C may begin playing the audio or video data before the entire file is transmitted from streaming servers 108A-F. Streaming servers 108A-F may compress data before transmission to computing devices 114A, 114B, or 114C using a variety of compression protocols as is well known to those of ordinary skill in the art.

In an embodiment, streaming servers 108A-F may communicate with user computing devices 114A, 114B, or 114C using any communication protocol known to a person of ordinary skill in the art, including transmission control protocol, file transfer protocol, real-time transfer protocols, real-time streaming protocol, real-time transport control protocol, or the like. These protocols may stream data from data sources 110A-F and 112 to computing devices 114A, 114B, or 114C under the control of streaming control device 106.

In an embodiment, streaming control device 106 may receive a unique identifier or address 105, e.g., an IP address, an autonomous system number (ASN), ASN plus community string, or subnet identifier, from network node 102 uniquely identifying network devices 104A or 104B or network node 102 or any combination thereof. An IP address may be an address used to uniquely identify a device, e.g., network devices 104A and 104B and node 102, on network 100. The IP address may be made up of a plurality of bits, e.g., 32 bits, which are divisible into a network portion and a host portion with the help of a subnet mask. Subnet masks may allow for the creation of logical segments or links that exist within network 100. Each data segment 120 on network 100 may have a unique network/subnetwork identifier 105. Network node 102 may assign or record a distinct identifier or address to every segment 120 that it interconnects. Network addressing is well known to a person or ordinary skill in the art and will not be further discussed herein.

In an embodiment, network node 102 may measure traffic statistics to determine performance and avoid congestion. Network node 102 may take performance measurements continuously or at predetermined times completely or partially automatically of network segment 120. Network congestion may exist when network node 102 is operating at substantially near a capacity that deteriorates its Quality of Service (QoS) or at substantially near a capacity that exceeds a predetermined threshold 103. QoS may be the result of monitoring discreet infrastructure components in network 100 such as network devices 104A or 104B. Network node 102 may measure traffic statistics including but not limited to central processing unit use, memory use, packet loss, delay, round trip times (RTT), jitter, error rates, throughput, availability, bandwidth, packet dropping probability, and the like.

In an embodiment, network node 102 may determine congestion based on direct user feedback. For example, a user may indicate a low rating or otherwise indicate dissatisfaction with the stream session to a corresponding one of streaming servers 108A-F, which, may in turn, signal the network node 102 (or the fabric manager). For another example, the network node or a corresponding one of streaming servers 108A-F may infer user dissatisfaction with the stream session (and hence congestion) based on user behavior, e.g., shorter sessions, user number drop, and the like. A person of ordinary skill in the art should recognize other user generated data that may be used to identify quality issues with stream session or network segment 120.

Network node 102 may determine that it is operating at a predetermined capacity on segment 120 that includes network devices 104A and 104B based at least in part on the measured traffic statistics. In an embodiment, network node 102 may determine that it is operating at a capacity, e.g., 95%, that exceeds predetermined threshold 103, e.g., 85%, of total capacity. Predetermined threshold 103 may be adjusted to reflect changes in network 100. For example, predetermined threshold 103 may be adjusted to reflect the addition or deletion of computing devices in network 100, to reflect a change in topology, or the like. In response to network node 102 determining that it is operating at a capacity that exceeds predetermined threshold 103, network node 102 may signal or initiate a call to streaming control device 106 with the unique identifier or address 105 that identifies congested segment 120. In an embodiment, network node 102 may transmit to streaming control device 106 an ASN, ASN plus community string, or subnet identifier identifying segment 120 or a group of IP subnets 105 within segment 120 that is or are operating at a capacity that exceeds predetermined threshold 103, thus signaling congestion.

In an embodiment, streaming control device 106 may identify which of streaming servers 108A-F have connections into segment 120 based on unique identifier 105 received from network node 102. Streaming control device 106 may identify streaming servers 108A, 108D, and 108F as streaming data to user computing devices 114A, 114B, and 114C with connections to segment 120. In an embodiment, streaming control device 106 may include a registry or look up table (not shown separately) to manage connections between streaming servers 108A, 108D, and 108F and computing devices 114A, 114B, and 114C including in some circumstances network metadata. Streaming control device 106 may use the look up table to identify streaming servers 108A, 108D, and 108F that are currently serving client computing devices 114A, 114B, or 114C within segment 120 that is experiencing network congestions and is signaling for a bit rate reduction.

In an embodiment, streaming control device 106 may limit a stream rate of streaming servers 108A, 108D, or 108F, or any combination thereof. Doing so, may control, reduce, or otherwise limit congestion of segment 120. In an embodiment, streaming control device 106 may downward adjust or delimit stream rate of streaming servers 108A, 108D, and 108F that stream data to computing devices 114A, 114B, or 114C within segment 120 in response to receiving an indication that congestion is above predetermined threshold 103 at network node 102. Streaming control device 106 may downward adjust a stream rate by applying a stream rate limit 107 to each of streaming servers 108A, 108D, or 108F such that none of streaming servers 108A, 108D, or 108F may stream data above stream rate limit 107 to at least a portion of user computing devices 114A, 114B, or 114C. Alternatively, streaming control device 106 may downward adjust the stream rate by applying stream rate limit 107 to a combination of streaming servers 108A, 108D, or 108F such that the combination may not stream data above stream rate limit 107 to at least a portion of user computing devices 114A, 114B, or 114C. Streaming control device 106 may apply stream rate limit 107 based on reducing or eliminating congestion at network node 102 but may also be based on other factors including various well-known performance metrics, e.g., Quality of Service (QoS) or Quality of Experience (QoE).

In an embodiment, streaming control device 106 may apply stream rate limit 107 to one, several, or all of the streaming servers 108A-F, physical or virtual machines executing on one or several physical servers, that are streaming to clients on affected network segments.

In an embodiment, streaming control device 106 may downward adjust streaming servers 108A, 108D, and 108F for a predetermined time period. Alternatively, streaming control device 106 may downward adjust streaming servers 108A, 108D, and 108F until streaming control device 106 receives an indication that capacity is below predetermined threshold 103 from network node 102, and thus, congestion is avoided or resolved. In an embodiment streaming control device 106 may implement stream rate limit 107 to streaming servers 108A, 108D, and 108F using a stepping mechanism with time delays to prevent a large drop in the bit rate in a short time period. Network node 102 may signal streaming control device 106 that it is at or near capacity or saturation, which, in turn, may apply stream control limit 107 by a predetermined amount, e.g., 128 Kbps, for a predetermined time, e.g., n minutes, to streaming servers 108A, 108D, and 108F. If network node 102 continues to signal streaming control server 106 that it continues to be at or near capacity after lapse of n minutes, streaming control device 106 may apply a further reduced stream control limit 107, e.g., of an additional 128 Kbps, for a further predetermined amount of time, e.g., another n minutes, to streaming servers 108A, 108D, and 108F. Streaming control device 106 may apply continue to apply a stepwise reduction in stream control limit 107 to streaming control servers 108A, 108D, and 108F until network node 102 signals that it is not at or near capacity or until a minimum stream rate is reached that ensures meeting or exceeding well-known performance metrics, e.g., QoS or QoE.

In an embodiment shown in FIG. 1C, streaming client computing devices 116A, 116B, and 116F may detect congestion or a drop in quality by measuring all manner of well-known traffic statistics, e.g., central processing unit use, memory use, packet loss, delay, round trip times (RTT), jitter, error rates, throughput, availability, bandwidth, packet dropping probability, and the like. Congested streaming client computing devices 116A, 116B, and 116F may alert streaming servers 108A, 108D, and 108F of the congestion that, in turn, may signal streaming control device 106 to lower the bit rate to all or a portion of streaming servers 108A-F streaming to all or a portion of client computing devices 116A-F. In an embodiment, streaming control device 106 may rely on, e.g., a fabric manager, to identify a pattern of congestion across client computing devices 116A, 116B, and 116F over multiple streaming servers 108A, 108D, and 108F. Streaming control device 106 may infer a common affected network segment based on a lookup table and proactively rate-limit additional streaming servers from that same network segment e.g., segment 120.

In an embodiment, streaming control device 106 may downward adjust or delimit stream rate of streaming servers 108A, 108D, and 108F that stream data to computing devices 116A, 116B, or 116F within segment 120 in response to receiving an indication that computing devices 116A, 116B, or 116F are experiencing congestion. Streaming control device 106 may downward adjust a stream rate by applying a stream rate limit 107 to each of streaming servers 108A, 108D, or 108F such that none of streaming servers 108A, 108D, or 108F may stream data above stream rate limit 107 to at least a portion of user computing devices 116A, 116B, or 116F.

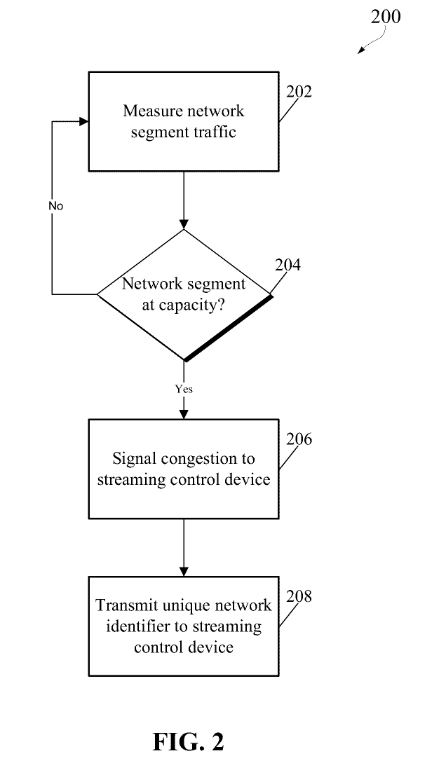

FIG. 2 diagrams an embodiment of a method 200 of managing network node bandwidth according to the present disclosure. Referring to FIGS. 1A, 1B, and 2, at 202, method 200 measures traffic statistics of a network segment to determine congestion. Method 200 may measure all manner of well-known traffic statistics of a network segment, e.g., central processing unit use, memory use, packet loss, delay, round trip times (RTT), jitter, error rates, throughput, availability, bandwidth, packet dropping probability, and the like. At 204, method 200 determines if the network segment is operating at a predetermined capacity based at least in part on the measured traffic statistics. In an embodiment, method 200 may determine that a particular network segment is operating at a capacity, e.g., 95%, that exceeds a predetermined threshold 103, e.g., 85%, of total capacity. Predetermined threshold 103 may be adjusted to reflect changes in network 100 or network segment 120, e.g., to reflect the addition or deletion of computing devices in network 100, to reflect a change in topology, or the like.

At 206, if the network segment is operating at a capacity that exceeds predetermined threshold 103, method 200 may signal congestion to streaming control device 106. At 208, method 200 may transmit a unique network identifier or address 105 that identifies the congested segment 120. In an embodiment, method 200 may transmit to streaming control device 106 an ASN, ASN plus community string, or subnet identifier 105 identifying segment 120 or a group of IP subnets within segment 120 that is or are operating at a capacity that exceeds predetermined threshold 103.

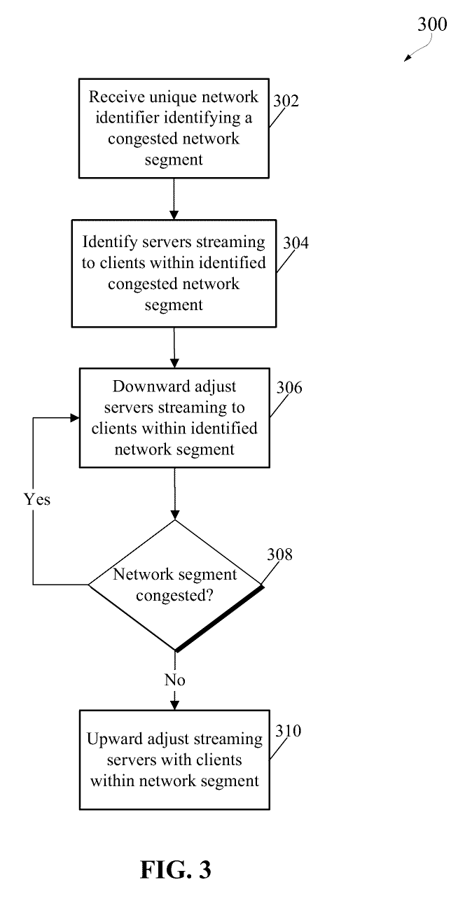

FIG. 3 diagrams an embodiment of a method 300 of managing network node bandwidth according to the present disclosure. Referring to FIGS. 1A, 1B, and 3, at 302, method 300 receives a unique network identifier or address 105 from network node 102 that uniquely identifies congested network segment 120. At 304, method 300 identifies streaming servers 108A, 108D, and 108F as streaming data to user computing devices 114A, 114B, or 114C with connections to congested network segment 120. At 306, method 300 downward adjusts or delimits stream rate 107 of the identified streaming servers 108A, 108D, or 108F to limit transmission and avoid congestion at segment 120. At 308, method 300 determines if network segment 120 remains congested and if so, further downward adjusts stream rate 107 of the identified streaming servers 108A, 108D, or 108F. Alternatively, method 300 maintains the downward adjustment of stream rate 107 of the identified streaming servers 108A, 108D, or 108F based on continued congestion of network segment 120. At 310, method 300 upward adjusts stream rate 107 of the identified streaming servers 108A, 108D, or 108F to a stream rate that prevents congestion at network segment 120.

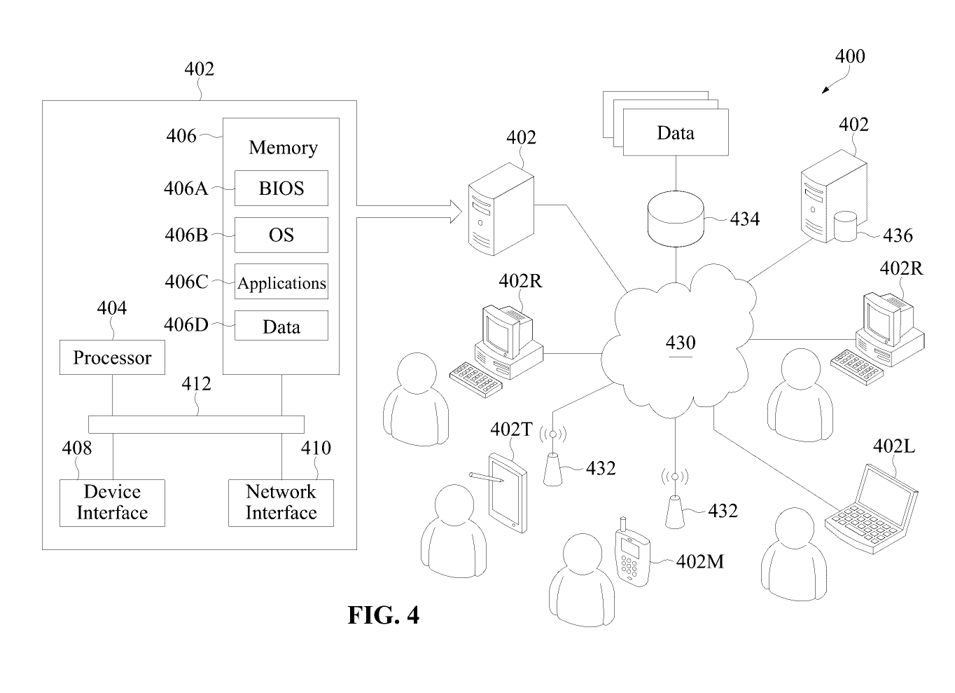

FIG. 4 diagrams an embodiment of a system 400 according to the present disclosure. Referring to FIG. 4, system 400 includes a computing device 402 that may represent network devices 104A or 104B, network node 102, streaming control device 106, streaming servers 108A-F, or user computing devices 114A-C shown in FIGS. 1A and 1B. Computing device 402 may execute instructions of application programs or modules stored in system memory, e.g., memory 406. The application programs or modules may include components, objects, routines, programs, instructions, data structures, and the like that perform particular tasks or functions or that implement particular abstract data types as discussed above. Some or all of the application programs may be instantiated at run time by a processing device 404. A person of ordinary skill in the art will recognize that many of the concepts associated with the exemplary embodiment of system 400 may be implemented as computer instructions, firmware, or software in any of a variety of computing architectures, e.g., computing device 402, to achieve a same or equivalent result.

Moreover, a person of ordinary skill in the art will recognize that the exemplary embodiment of system 400 may be implemented on other types of computing architectures, e.g., general purpose or personal computers, hand-held devices, mobile communication devices, gaming devices, music devices, photographic devices, multi-processor systems, microprocessor-based or programmable consumer electronics, minicomputers, mainframe computers, application specific integrated circuits, and like. For illustrative purposes only, system 400 is shown in FIG. 4 to include computing devices 402, geographically remote computing devices 402R, tablet computing device 402T, mobile computing device 402M, and laptop computing device 402L. A person of ordinary skill in the art may recognize that computing device 402 may be embodied in any of tablet computing device 402T, mobile computing device 402M, or laptop computing device 402L. Mobile computing device 402M may include mobile cellular devices, mobile gaming devices, mobile reader devices, mobile photographic devices, and the like.

A person of ordinary skill in the art will recognize that an exemplary embodiment of system 400 may be implemented in a distributed computing system in which various computing entities or devices, often geographically remote from one another, e.g., computing device 402 and remote computing device 402R, perform particular tasks or execute particular objects, components, routines, programs, instructions, data structures, and the like. For example, the exemplary embodiment of system 400 may be implemented in a server/client configuration (e.g., computing device 402 may operate as a server and remote computing device 402R may operate as a client). In distributed computing systems, application programs may be stored in local memory 406, external memory 436, or remote memory 434. Local memory 406, external memory 436, or remote memory 434 may be any kind of memory, volatile or non-volatile, removable or non-removable, known to a person of ordinary skill in the art including random access memory (RAM), flash memory, read only memory (ROM), ferroelectric RAM, magnetic storage devices, optical discs, and the like.

The computing device 402 comprises processing device 404, memory 406, device interface 408, and network interface 410, which may all be interconnected through bus 412. The processing device 404 represents a single, central processing unit, or a plurality of processing units in a single or two or more computing devices 402, e.g., computing device 402 and remote computing device 402R. The local memory 406, as well as external memory 436 or remote memory 434, may be any type memory device known to a person of ordinary skill in the art including any combination of RAM, flash memory, ROM, ferroelectric RAM, magnetic storage devices, optical discs, and the like. The local memory 406 may store a basic input/output system (BIOS) 406A with routines executable by processing device 404 to transfer data, including data 406D, between the various elements of system 400. The local memory 406 also may store an operating system (OS) 406B executable by processing device 404 that, after being initially loaded by a boot program, manages other programs in the computing device 402. Memory 406 may store routines or programs executable by processing device 404, e.g., applications or programs 406C. Applications or programs 406C may make use of the OS 406B by making requests for services through a defined application program interface (API). Applications or programs 406C may be used to enable the generation or creation of any application program designed to perform a specific function directly for a user or, in some cases, for another application program. Examples of application programs include word processors, database programs, browsers, development tools, drawing, paint, and image editing programs, communication programs, and tailored applications as the present disclosure describes in more detail, and the like. Users may interact directly with computing device 402 through a user interface such as a command language or a user interface displayed on a monitor (not shown).

Device interface 408 may be any one of several types of interfaces. The device interface 408 may operatively couple any of a variety of devices, e.g., hard disk drive, optical disk drive, magnetic disk drive, or the like, to the bus 412. The device interface 408 may represent either one interface or various distinct interfaces, each specially constructed to support the particular device that it interfaces to the bus 412. The device interface 408 may additionally interface input or output devices utilized by a user to provide direction to the computing device 402 and to receive information from the computing device 402. These input or output devices may include voice recognition devices, gesture recognition devices, touch recognition devices, keyboards, monitors, mice, pointing devices, speakers, stylus, microphone, joystick, game pad, satellite dish, printer, scanner, camera, video equipment, modem, monitor, and the like (not shown). The device interface 408 may be a serial interface, parallel port, game port, firewire port, universal serial bus, or the like.

A person of ordinary skill in the art will recognize that the system 400 may use any type of computer readable medium accessible by a computer, such as magnetic cassettes, flash memory cards, compact discs (CDs), digital video disks (DVDs), cartridges, RAM, ROM, flash memory, magnetic disc drives, optical disc drives, and the like. A computer readable medium as described herein includes any manner of computer program product, computer storage, machine readable storage, or the like.

Network interface 410 operatively couples the computing device 402 to one or more remote computing devices 402R, tablet computing devices 402T, mobile computing devices 402M, and laptop computing devices 402L, on a local, wide, or global area network 430. Computing devices 402R may be geographically remote from computing device 402. Remote computing device 402R may have the structure of computing device 402, or may operate as server, client, router, switch, peer device, network node, or other networked device and typically includes some or all of the elements of computing device 402. Computing device 402 may connect to network 430 through a network interface or adapter included in the interface 410. Computing device 402 may connect to network 430 through a modem or other communications device included in the network interface 410. Computing device 402 alternatively may connect to network 430 using a wireless device 432. The modem or communications device may establish communications to remote computing devices 402R through global communications network 430. A person of ordinary skill in the art will recognize that applications or programs 406C might be stored remotely through such networked connections. Network 430 may be local, wide, global, or otherwise and may include wired or wireless connections employing electrical, optical, electromagnetic, acoustic, or other carriers.

The present disclosure may describe some portions of the exemplary system using algorithms and symbolic representations of operations on data bits within a memory, e.g., memory 406. A person of ordinary skill in the art will understand these algorithms and symbolic representations as most effectively conveying the substance of their work to others of ordinary skill in the art. An algorithm is a self-consistent sequence leading to a desired result. The sequence requires physical manipulations of physical quantities. Usually, but not necessarily, these quantities take the form of electrical or magnetic signals capable of being stored, transferred, combined, compared, and otherwise manipulated. For simplicity, the present disclosure refers to these signals as bits, values, elements, symbols, characters, terms, numbers, or like. The terms are merely convenient labels. A person of skill in the art will recognize that terms such as computing, calculating, generating, loading, determining, displaying, or like refer to the actions and processes of a computing device, e.g., computing device 402. The computing device 402 may manipulate and transform data represented as physical electronic quantities within a memory into other data similarly represented as physical electronic quantities within the memory.

It will also be appreciated by persons of ordinary skill in the art that the present disclosure is not limited to what has been particularly shown and described hereinabove. Rather, the scope of the present disclosure includes both combinations and sub-combinations of the various features described hereinabove as well as modifications and variations which would occur to such skilled persons upon reading the foregoing description. Thus the disclosure is limited only by the appended claims.

1. A system, comprising:
a memory device configured to store instructions; and
a processing device configured to execute the instructions stored in the memory to:
receive a network identifier uniquely identifying a network segment that is operating at or near capacity;
identify at least one streaming server that is streaming to the network segment based at least in part on the network identifier; and
apply a stream rate limit to the at least one streaming server to limit a stream rate of the at least one streaming server to at least one client in the network segment.

2. The system of claim 1, wherein the network identifier comprises an autonomous system number or a subnet identifier.

3. The system of claim 1, wherein the network identifier uniquely identifies a network segment that is within a predetermined threshold of maximum capacity.

4. The system of claim 1, wherein the network identifier uniquely identifies a network segment that is within a predetermined percentage of maximum capacity.

5. The system of claim 1, wherein the processing device is further configured to apply the stream rate limit to the at least one streaming server for a predetermined period of time.

6. The system of claim 1, wherein the processing device is further configured to apply the stream rate limit to the at least one streaming server until the network segment is no longer operating at or near capacity.

7. The system of claim 1, wherein the processing device is further configured to remove the stream rate limit to the at least one streaming server in response to receiving an indication that the network segment is no longer operating at or near capacity.

8. A method, comprising:
receiving, by a streaming control device, a network identifier uniquely identifying a network segment that is operating substantially near capacity;
identifying, by the streaming control device, at least one streaming server that is streaming to at least one client in the network segment based at least in part on the network identifier; and
applying, by the streaming control device, a stream rate limit to the at least one streaming server to limit a stream rate from the at least one server to the at least one client.

9. The method of claim 8, wherein the network identifier comprises an autonomous system number or a subnet identifier.

10. The method of claim 8, wherein the network identifier uniquely identifies a network segment that is within a predetermined threshold of maximum capacity.

11. The method of claim 8, wherein the network identifier uniquely identifies a network segment that is within a predetermined percentage of maximum capacity.

12. The method of claim 8, further comprising applying, by the streaming control device, the stream rate limit to the at least one streaming server for a predetermined period of time.

13. The method of claim 8, further comprising applying, by the streaming control device, the stream rate limit to the at least one streaming server in response to the network segment no longer operating substantially near capacity.

14. The method of claim 8, further comprising removing, by the streaming control device, the stream rate limit to the at least one streaming server in response to receiving an indication that the network segment is no longer operating substantially near capacity.

15. A method, comprising:
determining an operating capacity of at least one network segment;
comparing the operating capacity with a maximum capacity of the at least one network segment;
transmitting a network identifier configured to uniquely identify the at least one network segment to a streaming control device based at least in part on the comparison;
causing the streaming control device to identify at least one streaming server configured to stream content to at least one client based at least in part on the network identifier; and
causing the streaming control device to limit a stream rate of the at least one streaming server.

16. The method of claim 15, wherein the network identifier comprises an autonomous system number or a subnet identifier.

17. The method of claim 15, wherein the network identifier uniquely identifies a network segment that is within a predetermined threshold of the maximum capacity.

18. The method of claim 15, wherein the network identifier uniquely identifies a network segment that is within a predetermined percentage of the maximum capacity.

19. The method of claim 15, further comprising causing the streaming control device to limit the stream rate of the at least one streaming server for a predetermined period of time.

20. The method of claim 15, further comprising causing the streaming control device to delimit the at least one streaming server in response to determining that the operating capacity of the network segment is no longer near maximum capacity.
